(19) United States
(12) Patent Application Publication
(10) Pub. No.: US 2008/0281012 A1
(43) Pub. Date: Nov. 13, 2008

(54) Block Copolymer Foam Additives

(75) Inventor: Brett L. Van Horn, Mont Clare, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 12/160,824

(22) PCT Filed: Jan. 18, 2007
(86) PCT No.: PCT/US07/01436

§ 371 Date: Jul. 14, 2008

Related U.S. Application Data
(60) Provisional application No. 60/760,330, filed on Jan. 19, 2006.

(51) Int. Cl. C08G 61/00

(52) U.S. Cl. 521/139

(57) ABSTRACT

The present invention provides an additive for thermoplastic polymer foams which provide for enlarged cell size or with decreased density with minimal impact on the thermal mechanical properties of the thermoplastic foam. The additive is an essentially block copolymer blowing agent compatibilizer. Including the additive in a thermoplastic foaming composition comprised of a thermoplastic polymer resin and a physical blowing agent provides for the production of foam having enlarged cell size or with decreased density and minimal impact on the thermal mechanical properties of the thermoplastic foam. The block copolymer compatibilizer has at least a first block having at least one functionality compatible with the thermoplastic resin and at least one second block having a functionality compatible with the blowing agent.

### FIELD OF THE INVENTION

The present invention relates to additives for thermoplastics foams. More particularly, the present invention relates to block copolymer additives for thermoplastic foams in which the block copolymer has one functionality that is compatible with the thermoplastic resin and one functionality that is compatible with the blowing agent. Such additives provide for thermoplastic foams with increased cell size or with decreased density. The block copolymer additives provide for a lower impact on the thermal mechanical properties of the foam product as compared to when random copolymer additives are used.

### BACKGROUND OF THE INVENTION

Many non-ozone depleting physical blowing agents used in the production of thermoplastic polymer foams suffer from the problem of having a high nucleation potential, being strong self-nucleators, which leads to foams with small cell sizes. Foams with decreased cell size can have low compression strength or the small cell size can be a problem with insulating foams if infrared attenuating agents are used. This is particularly a problem when foaming polystyrene with HFC-134a for producing thermal insulating foams.

U.S. Pat. No. 4,229,396, as reference in U.S. Pat. No. 5,993,706, provides an example of a method of adding a wax to the foaming gel to increase the foam cell size. The wax, however, can cause problems with thermal stability, extrusion temperature inconsistency, or poor physical properties.

Attempts to use non-waxy components to produce enlarged cell size foams include U.S. Pat. No. 5,489,407. U.S. Pat. No. 5,776,389 discloses the use of glycerol monoesters of C8-C24 fatty acids as cell size enlargers. However, unless used in small concentrations, these materials depress the glass transition temperature of the polymer which will degrade the thermal physical properties of the foam such as the heat distortion temperature or creep under load at elevated temperatures.

U.S. Pat. No. 5,993,706 addresses this issue in closed-cell alkyl aromatic polymer (e.g. polystyrene) foams by including in the foamable polymer melt 0.3 to 20 percent by weight of an essentially random interpolymer, preferably an ethylene/styrene based random interpolymer. The patent discloses cell size enlargement of 5% or more, preferably 10% or more, and more preferably 15% or more relative to the corresponding foam without the cell size enlarger. For some applications, such as thermal insulation, it is important the blowing agent remain in the cells. HFC-134a has a high diffusion rate through polyethylene, so incorporating ethylene based polymers into the resin may sacrifice the long term thermal insulative properties of the foam. Furthermore, if the interpolymer is uniformly dispersed throughout the resin then it may have detrimental effects on the bulk physical properties of the foam.

U.S. Pat. No. 5,426,125 provides a process for the production of styrenic polymer foam blown with carbon dioxide using polymers with oxygen-containing monomeric units for the purposes of significantly reducing the extrusion operating pressures. Examples include styrene/butyl acrylate based copolymer. The copolymers have a high styrene content and are presumably essentially random copolymers; they are expected to disperse the butyl acrylate uniformly in the resin which will drop the glass transition temperature or decrease the overall modulus of the resin and lead to poor thermal physical properties such as a low heat distortion temperature or poor thermal stability. In U.S. Pat. No. 5,426,125, the inventors observed, and thought it surprising, that their invention lead to foams having enlarged cell size over corresponding foams without the additive. The present invention has the advantage that the copolymer additives are block copolymers and designed to microphase separate when blended with the bulk resin. This way the discrete domains of the copolymer will not have the same detrimental effects on the bulk properties of the foam.

U.S. Pat. No. 6,787,580 discloses a process for the production of foam using so-called blowing agent stabilizers for the purposes of producing low-density, closed-cell foam with bimodal or mulimodal cell size distribution. The blowing agent stabilizers include block copolymers.

HFC-134a has been mentioned in the prior patents as a blowing agent while carbon dioxide was typically used as the blowing agent in the examples. Carbon dioxide does not have as strong of a nucleation potential as HFC-134a, and can have a nucleation density a couple of orders of magnitude less than 134a (Vachon and Gendron (2003) “Foaming Polystyrene with Mixtures of Carbon Dioxide and HFC-134a”, Cellular Polymers 22(2):75-87). Therefore it may be less challenging to produce foams with enlarged cell size using carbon dioxide than 134a.

### BRIEF DESCRIPTION OF THE DRAWINGS

FIG. 1 is a graph showing the storage modulus, G′, and the loss tangent, tan δ, of DMA scans for the Samples 1 through 5 for the entire temperature range tested.

FIG. 2 is a close-up of DMA scans of FIG. 1 for a temperature range of approximately 40-130° C. and G′>10⁸ Pa.

### DETAILED DESCRIPTION OF THE INVENTION

This present invention provides a process for the production of thermoplastic polymer foams with enlarged cell size or with decreased density. An embodiment of the invention is that the foaming composition is comprised of the thermoplastic polymer resin, the physical blowing agent, and an essentially block copolymer blowing agent compatibilizer. The block copolymer is designed to have at least one functionality compatible with the thermoplastic resin and at least one functionality compatible with the blowing agent. Preferably the block copolymer is designed such that when blended with the thermoplastic resin it will microphase separate, forming evenly distributed discrete domains of the block copolymer. In this way, the block copolymer blowing agent compatibilizer will not have a significant impact on the glass transition temperature or the overall modulus of the bulk resin and therefore less impact on the thermal physical properties of the bulk foam, whereby those properties will be dominated by the thermoplastic resin.

A possible effect of using polymer additives which exhibit a soft, low glass transition temperature (Tg) units such as poly(butyl acrylate) (with a Tg of approximately −54 to −49° C.) with thermoplastic resins with higher Tg such as polystyrene (with a Tg approximately 110 to 115° C.) is the tendency to soften, or lower the modulus, of the combination resin. With thermoplastic foams, the lower modulus will soften the final foamed product and/or decrease its heat distortion temperature. This effect can be seen when the mixture of additive and resin form a uniform, homogeneous blend.

It is known that blends of thermoplastic homopolymer resins with block copolymers can form non-homogeneous blends with microphase separated structures. In some cases these structures form small, discrete domains of the block copolymer additive component within a matrix of the homopolymer resin. Even though such a blend may contain a significant fraction of low Tg block copolymer material, the microphase separated structure isolates the “soft” component into discrete droplets leaving a continuous matrix of the “harder” resin. The result is to minimize the effects of the block copolymer additive on the Tg and modulus of the resin blend as compared to a similar blend which uses a non-microphase separating copolymer additive, such as with many random copolymers. Many factors effect miscibility and microphase separation in blends of homopolymer resins and block copolymer additives, including, but not limited to, polymer and copolymer composition, molecular weights of the homopolymer and copolymer block units, fraction of additive in the blend, temperature, the presence of other additives, etc.

It was discovered that when adding a block copolymer having at least one block compatible with the thermoplastic resin and at least one block compatible with the blowing agent to a thermoplastic resin/blowing agent combination resulting in a block copolymer which would microphase separate, forming evenly distributed discrete domains of the block copolymer that the microphase separated block copolymer blowing agent compatibilizer does not have a significant impact on the glass transition temperature or the overall modulus of the bulk resin and therefore less impact on the thermal physical properties of the bulk foam. Those properties are thus dominated by the thermoplastic resin. The block copolymer of the present invention is preferably a di-block copolymer but may be a tri-block or multi-block copolymer. The block copolymers of the present invention are preferably formed via controlled radical polymerization techniques whereby the physical properties of the block copolymer can be carefully controlled.

Exemplary block copolymers are block copolymers of polystyrene/poly(butyl acrylate) (PS/PBA) and triblock copolymers of polystyrene/poly(butyl acrylate)/polystyrene (PS/PBA/PS). Although the exemplary copolymers of the present invention were selected for use with HFC-134a (1,1,1,2 tetrafluoroethane) as the blowing agent, other blowing agents can be used including those comprising other HFCs, such as 1,1-difluoroethane (HFC-152a), difluoromethane (HFC-32), 1,1,1,3,3-pentafluoropropane (HFC-245fa), pentafluoroethane (HFC-125), 1,1,1-trifluoroethane (HFC-143a), 1,1,2-trifluoroethane, 1,1,1,2,3,3,3-heptafluoropropane (HFC-227ea), 1,1,1,3,3-pentafluorobutane (HFC-365mfc), and alkanes, such as pentane or butane, carbon dioxide, or mixtures thereof.

As mentioned, the copolymer will act as a compatibilizer between the bulk resin and the blowing agent. In testing, polystyrene was used as the bulk thermoplastic resin, and polystyrene was chosen as the functionality of the block copolymer that is compatible with the resin. Poly(butyl acrylate) was selected as the functionality compatible with the HFC-134a blowing agent based upon solubility studies using inverse gas chromatography and based upon solubility studies in literature, particularly Wood and Cooper (2003) Macromol 36:7534-7542, which studied the solubility of several polymers in liquid HFC-134a. Furthermore, it is desirable to have a polymeric unit that is easy to make block copolymers with polystyrene and which is inexpensive. These properties make poly(butyl acrylate) a preferred choice for the HFC-134a compatible block of the block copolymer compatibilizer.

The copolymer compatibilizers of the present invention can also have uses in producing thermoplastic foams of decreased density due to the added compatibility between the blowing agent and copolymer.

The present invention is illustrated in more detail in the following non-limiting examples.

### EXAMPLE 1

Two polystyrene (PS) homopolymer resins were used in this example. PS-250 and PS-170 having weight average molecular weights of 250,000 g/mol and 170,000 g/mol respectively as determined by gel permeation chromatography (GPC). The block copolymer additives used were synthesized via controlled radical polymerization. The PS-PBA employed was a block copolymer of polystyrene and poly(butyl acrylate) (PBA) where the styrene block had a molecular weight of 84,000 g/mol and the poly(butyl acrylate) block had molecular weight of 123,000 g/mol. A random copolymer of 64 wt % styrene and 36 wt % butyl acrylate, P(S-r-BA), was also use.

Polymer blends were prepared by compounding a PS homopolymer with a predetermined quantity of a copolymer additive using a micro-extruder operated at 150 rpm, with set point temperatures of 200° C., melt temperature approximately 190° C., for approximately 6 minutes. The blended compositions were selected to produce blends with an equivalent butyl acrylate content of 10 wt % butyl acrylate. Samples were further heat pressed into rectangular bars with sample dimensions of approximately 2 in×0.5 in×0.0625 in. Samples of PS-250 and PS-170 were also processed under the same conditions to yield samples with the same thermal history. The properties of the samples tested are summarized in Table 1:

TABLE 1
Polymer Blends of Polystyrene Resin with Copolymer Additives

| | | | | | Butyl |
|---|---|---|---|---|---|
| | Composition (wt %) | | | | acrylate |
| Sample | PS-250 | Ps-170 | PS-PBA | P(S-r-BA) | content |
| 1 | 100% | — | — | — | 0% |
| 2 | — | 100% | — | — | 0% |
| 3 | 83.2% | — | 16.8% | — | 10% |
| 4 | — | 83.2% | 16.8% | — | 10% |
| 5 | — | 72.2% | — | 27.8% | 10% |

### Blend Homogeneity

The homogeneity of these polymer blends was observed using Atomic Force Microscopy (AFM). Prior to AFM and optical imaging the samples were trimmed and cryomicrotomed. AFM images were taken in tapping mode and phase and height data were recorded. Etched silicon cantilevers (RTESP14 from VEECO) with a resonance frequency of around 300 kHz were used. The lateral size of all images is 5 μm×5 μm. The set point, proportional and integral gains as well as the scan rate were adjusted to optimize image quality. The scan angle was always 90° C.

Samples 3 and 4 exhibited distinct microphase separation with evenly distributed oval to spherical domains of poly(butyl acrylate) ranging from about 20 to 250 nm in diameter. Sample 5 was uniform, showing no domains and no phase separation.

### Thermal Mechanical Properties

Glass transition temperatures and moduli were determined using Dynamic Mechanical Analysis (DMA). Testing was performed at a frequency of 1 Hz, heating rate of 5° C. per minute from −140 to 140° C., and strain ranging from 0.03 to 0.5%. All testing was conducted under a nitrogen atmosphere.

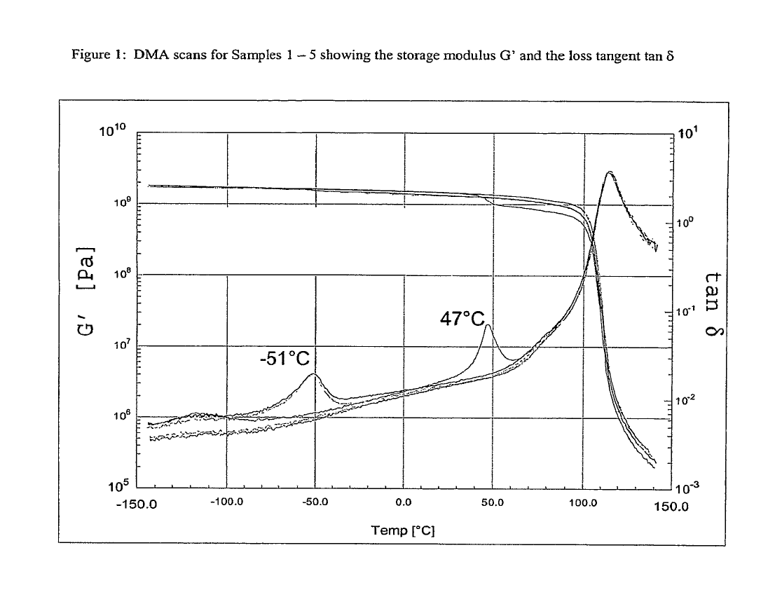

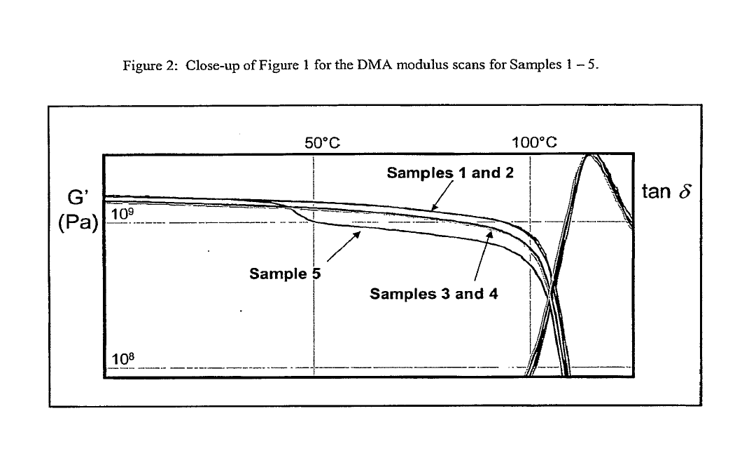

DMA scans for the samples are shown in FIGS. 1 and 2. The glass transition temperatures are evident as the peaks in the tan δ curves of FIG. 1. The polystyrene homopolymers, Samples 1 and 2, had nearly identical storage modulus scans (G′) across the entire temperature range and both were found to have a Tg of 114.6° C. as shown in FIG. 1. Samples with copolymer additives showed two distinct glass transition temperatures, one approximately that of the base resin of polystyrene and the other corresponding to the additive. Furthermore, the storage modulus of the blends was lower than that of the reference resins, Samples 1 and 2. However, Samples with a block copolymer additive, Samples 3 and 4, had a significantly higher modulus than the sample with a random copolymer additive, Sample 5, for temperatures above 47° C., as shown in FIG. 2. Results are summarized in the Tables 2 and 3.

For the storage modulus, G′, representative values were selected from the modulus scans in FIG. 1 at four different temperatures, from 25° C. to 90° C. These values are shown in Table 3 along with the %-difference in the storage modulus from the value for Sample 1 at that temperature. For Sample 5, at temperatures greater than its Tg₁=47° C., the modulus is significantly lower than for pure polystyrene, more than 26% lower than the modulus of Sample 1. However, for the same temperature range, the moduli of Samples 3 and 4 are less than 14% lower than the pure polystyrene modulus. Between −51° C. and 47° C., the moduli of Samples 3 and 4 were still slightly lower than the pure polystyrene while the modulus of Sample 5 is approximately that of Samples 1 and 2 since the temperature is <Tg₁ of Sample 5 (47° C.).

TABLE 2
Glass transition temperatures, Tg

| | Tg₁ | Tg₂ |
|---|---|---|
| Sample | (° C.) | (° C.) |
| 1,2 | — | 114.6 |
| 3 | −51 | 114 |
| 4 | −51 | 114 |
| 5 | 47 | 113 |

TABLE 3
Resin Storage Modulus, G′

| | @25° C. | | @50° C. | | @70° C. | | @90° C. | |
|---|---|---|---|---|---|---|---|---|
| | G′ | %- | G′ | %- | G′ | %- | G′ | %- |
| Sample | (Pa) | diff | (Pa) | diff | (Pa) | diff | (Pa) | diff |
| 1 | 1.46 | — | 1.37 | — | 1.25 | — | 1.05 | — |
| | 10⁹ | | 10⁹ | | 10⁹ | | 10⁹ | |
| 2 | 1.47 | 1% | 1.38 | 1% | 1.26 | 1% | 1.07 | 2% |
| | 10⁹ | | 10⁹ | | 10⁹ | | 10⁹ | |
| 3 | 1.31 | 10% | 1.23 | 11% | 1.11 | 12% | 9.2 | 13% |
| | 10⁹ | | 10⁹ | | 10⁹ | | 10⁸ | |
| 4 | 1.35 | 8% | 1.26 | 8% | 1.13 | 9% | 9.2 | 12% |
| | 10⁹ | | 10⁹ | | 10⁹ | | 10⁸ | |
| 5 | 1.46 | 0% | 1.00 | 27% | 8.8 | 30% | 7.3 | 31% |
| | 10⁹ | | 10⁹ | | 10⁸ | | 10⁸ | |

These results show that using block copolymers in accordance with the present invention results in the formation of dispersed, microphase separated domains when blended with a thermoplastic resin, such as polystyrene. The use of the block copolymer additive minimizes the adverse effects on the thermal and mechanical properties of the blend when the copolymer additive has a lower glass transition temperature than the thermoplastic. When random copolymers were added which were miscible with the thermoplastic, Sample 5, the effects on the thermal mechanical properties of the blends were much greater.

While the present invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

1. A thermoplastic foam comprising a thermoplastic resin, a blowing agent and a block copolymer comprising at least a first block and a second block, wherein said first block includes at least one functionality compatible with said thermoplastic resin and said second block includes at least one functionality compatible with said blowing agent.

2. The thermoplastic foam of claim 1 wherein said first block comprises polystyrene.

3. The thermoplastic foam of claim 1 wherein said second block comprises poly(butyl acrylate).

4. The thermoplastic foam of claim 1 wherein said block copolymer is an ABA triblock copolymer wherein A represents said first block and B represents said second block.

5. The thermoplastic foam of claim 1 wherein said blowing agent is selected form the group consisting of 1,1,1,2 tetrafluoroethane, 1,1-difluoroethane, difluoromethane, 1,1,1,3,3-pentafluoropropane, pentafluoroethane, 1,1,1-trifluoroethane, 1,1,2-trifluoroethane, 1,1,1,2,3,3,3-heptafluoropropane, 1,1,1,3,3-pentafluorobutane, alkanes, carbon dioxide, and mixtures thereof.

6. A method of forming a thermoplastic foam from a thermoplastic resin and a blowing agent comprising combining said thermoplastic resin and said blowing agent and adding a block copolymer comprising at least a first block and a second block, wherein said first block includes at least one functionality compatible with said thermoplastic resin and said second block includes at least one functionality compatible with said blowing agent.

7. The method of claim 6 wherein said first block comprises polystyrene.

8. The method of claim 6 wherein said second block comprises poly(butyl acrylate).

9. The method of claim 6 wherein said block copolymer is an ABA triblock copolymer wherein A represents said first block and B represents said second block.

10. The method of claim 6 wherein said blowing agent is selected form the group consisting of 1,1,1,2 tetrafluoroethane, 1,1-difluoroethane, difluoromethane, 1,1,1,3,3-pentafluoropropane, pentafluoroethane, 1,1,1-trifluoroethane, 1,1,2-trifluoroethane, 1,1,1,2,3,3,3-heptafluoropropane, 1,1,1,3,3-pentafluorobutane, alkanes, carbon dioxide, and mixtures thereof.
